(19) United States
(12) Patent Application Publication
(10) Pub. No.: US 2006/0050391 A1
(43) Pub. Date: Mar. 9, 2006

(54) Structured-groove diffraction granting and method for control and optimization of spectral efficiency

(76) Inventors: Johan Backlund, Gothenburg (SE); Daniel W. Wilson, Montrose, CA (US); Pantazis Mouroulis, Glendora, CA (US); Paul D. Maker, San Marcos, CA (US); Richard E. Muller, Altadena, CA (US)

Correspondence Address: Alessandro Steinfl, Esq.;c/o LADAS & PARRY, Suite 2100, 5670 Wilshire Boulevard, Los Angeles, CA, 90036-5679, US

(21) Appl. No.: 11/198,869

(22) Filed: Aug. 4, 2005

Related U.S. Application Data
(60) Provisional application No. 60/600,308, filed on Aug. 10, 2004.

(51) Int. Cl. G02B 5/18

(52) U.S. Cl. 359/573; 359/569

(57) ABSTRACT

A method for fabricating an optical diffraction element or grating, where the spectral response of phase gratings is substantially optimized by introducing structure into the grating groove profile. Spectral range of the grating is extended when compared to conventional blazed gratings.

### CROSS REFERENCE TO RELATED APPLICATIONS

This application claims the benefit of U.S. provisional Patent Application Ser. No. 60/600,308, filed Aug. 10, 2004 for a “Structured-Groove Diffraction Grating for Control and Optimization of Spectral Efficiency” by Johan Backlund, Daniel W. Wilson, Pantazis Mouroulis, Paul D. Maker and Richard E. Muller, the disclosure of which is incorporated herein by reference in its entirety.

### STATEMENT OF FEDERAL INTEREST

The invention described herein was made in the performance of work under a NASA contract, and is subject to the provisions of Public Law 96-517 (35 USC § 202) in which the Contractor has elected to retain title.

### FIELD

The present disclosure relates to diffraction gratings and, in particular, to a method to obtain structured groove diffraction gratings for control and optimization of spectral efficiency.

Throughout the description of the present disclosure, reference will be made to the enclosed Annex A, which makes part of the present disclosure.

### BACKGROUND

An approach to control the spectral efficiency response of a grating in terms of efficiency vs. wavelength is to deposit dielectric layers on top of a conventional blazed grating to accomplish a spectral bandpass filter function.

Further, there have been attempts to engineer the grating profile intuitively to accomplish a certain control of the spectral response.

According to a further prior art approach, the grating is divided into two or more areas where each area is a conventional sawtooth blaze grating but with different blaze angles and different peak efficiency, as shown in FIG. 1.

The dual-blaze gratings shown in FIG. 1 split the grating aperture into two zones, concentric (left portion of FIG. 1) or side-by-side (right portion of FIG. 1) with different sawtooth blaze angles in each zone. Although this gives the designer some control over the efficiency vs. wavelength response of the total grating area, these dual blaze gratings exhibit severe wavelength-dependent apodization because only one grating zone area is bright at a given wavelength. This zonal apodization can reduce the spectral imaging quality of the system due to point-spread function degradation and centroid shifting. Such effects must be accounted for during design, making optimization a laborious process. In addition, the total efficiency is not optimized.

However, none of the above techniques can synthesize an optimized arbitrary desired spectral response, thus leaving the designer with very little room to fulfill specific design goals.

### SUMMARY

The method according to the present disclosure allows to fully realize the potential of diffraction gratings with an optimized spectral response using precisely structured groove shapes.

There is a need to design more advanced gratings that optimize the performance of a spectroscopic instrument in form of efficiency, image quality, and spectral range compared to using conventional gratings.

According to a first aspect, a method for designing a groove profile of a grating is disclosed, comprising: defining one or more targets as spatial frequency components within a predetermined spectral range, said targets being based on wavelength and diffraction order; dividing the grating groove into a number of sections; defining a relation between a grating profile comprised of said sections and a diffraction efficiency in said spatial frequency components; and adjusting individual heights of each section.

According to a second aspect, a method for fabricating a periodic diffractive optical element is disclosed, comprising: specifying a wavelength range and diffraction angles of the diffractive optical element; specifying a desired efficiency of the diffractive optical element; sampling an efficiency function for the diffractive optical element at discrete wavelengths and diffraction orders, thus defining efficiency targets; dividing a grating area of the diffractive optical element into depth cells; and finding a desired value for each depth cell.

According to a third aspect, a diffraction grating is disclosed, comprising: a structured groove profile, wherein said structured groove profile is optimized to achieve a desired efficiency vs. wavelength function.

According to a fourth aspect, a spectral domain method to obtain a desired efficiency of a plurality of grooves in a diffraction element is disclosed, comprising: specifying relative efficiency targets at specific wavelengths and diffraction orders; defining grooves as comprising pixel depths; for each pixel, finding a pixel depth that optimizes a field contribution of said pixel to all targets simultaneously; calculating diffraction efficiencies for all targets; adjusting target weights; and repeating said adjusting until said desired efficiency is obtained or stagnation occurs.

The structured-groove gratings in accordance with the present disclosure eliminate the need for multiple blaze zones and allow the grating to be treated as a uniform area. Hence the designer will be able to use the full power of the optical design software to optimize the imaging performance without concern for grating apodization effects.

### BRIEF DESCRIPTION OF THE DRAWINGS

FIG. 1 shows the structure of a prior art dual-blaze grating.

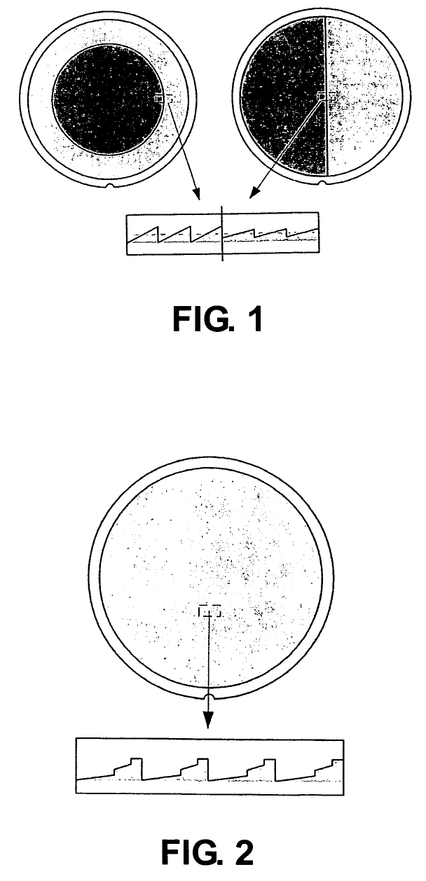

FIG. 2 shows an example of a structured grating profile.

FIG. 3 shows a flowchart of an algorithm used in accordance with the method of the present disclosure.

FIG. 4 shows a schematic view of a reflective CTIS optical system.

FIGS. 5A and 5B, discussed in Annex A, show schematic pictures of (3×3) grating periods (drawn as a chessboard for clarity) and one grating period sampled into H cells, respectively.

FIG. 6, discussed in Annex A, shows reflection and transmission mode reference coordinate systems for the incident and diffracted spatial frequency component.

FIG. 7, discussed in Annex A, shows a complex plane representation of two target fields. The field contribution for one single cell h is shown as the smaller vectors before and after a phase change of that cell. The total field change in the targets as a result of the cell phase change is also shown.

FIG. 8, discussed in Annex A, shows the design algorithm performance for four targets.

FIG. 9A, discussed in Annex A, shows the incident field direction on the grating and the final designed grating profile. FIG. 9B, discussed in Annex B, shows the simulated performance with respect to the targets shown as circles.

FIG. 10, discussed in Annex A, shows an AFM picture of a fabricated grating.

FIG. 11, discussed in Annex A, shows the measured spectral response (black) compared to vectorial (gray) and scalar (light-gray) simulations. The dotted curve shows the simulated (vectorial) performance of a linear sawtooth blazed grating.

FIG. 12, discussed in Annex A, shows four targets as circles with their respective wavelength and order given within parentheses, together with the simulated performance along with an inset depicting the incident and diffracted fields.

FIG. 13, discussed in Annex A, shows the measured spectral response (solid) for three orders, (−1, 0, 1), and compared to vectorial (dashed) and scalar (dotted) simulations. The inset of FIG. 13 shows an AFM-picture of the fabricated grating.

FIG. 14A, discussed in Annex A, shows a schematic picture of the incident and diffracted field directions from a two-dimensional grating. FIG. 14B, discussed in Annex A, shows the design targets, indicated by circles, selected along the spectrum for the respective order. The simulated spectral response is shown for all four orders as well.

FIG. 15A, discussed in Annex A, shows a designed grating profile. FIG. 15B, discussed in Annex A, shows an AFM picture of the fabricated grating profile. FIG. 16, discussed in Annex A, shows the measured spectral response in all four diffraction orders (black) compared to scalar simulations (light gray).

### DETAILED DESCRIPTION

In accordance with the present disclosure, the grating groove profile itself can be designed to generate an optimized arbitrary desired spectral response. This is not only beneficial in terms of the flexibility to tailor the spectral efficiency but also one single grating can be used to contribute for the whole spectral range -as later explained in more detail- thus providing a major image quality advantage for a spectral imaging instrument.

The method in accordance with the present disclosure comprises a new design algorithm, which includes a modification to the “optimal rotation angle” (ORA) used in the prior art to design spatial diffractive optics.

The ORA algorithm is described, for example, in J. Bengtsson, “Design of fan-out kinoforms in the entire scalar diffraction regime with an optimal-rotation-angle method”, Appl. Opt. 36, 8453-8444 (1997), and J. Bengtsson, “Kinoforms designed to produce different fan-out patterns for two wavelengths”, Appl. Opt. 37, 2011-2020 (1998), both of which are incorporated herein by reference in their entirety. The original (ORA) algorithm iteratively adjusts the depths of pixels in a surface-relief profile to optimize the amount of light diffracted to desired spatial locations.

The algorithm of the present disclosure is implemented completely within the spatial frequency domain, thus providing efficiency and accuracy advantages.

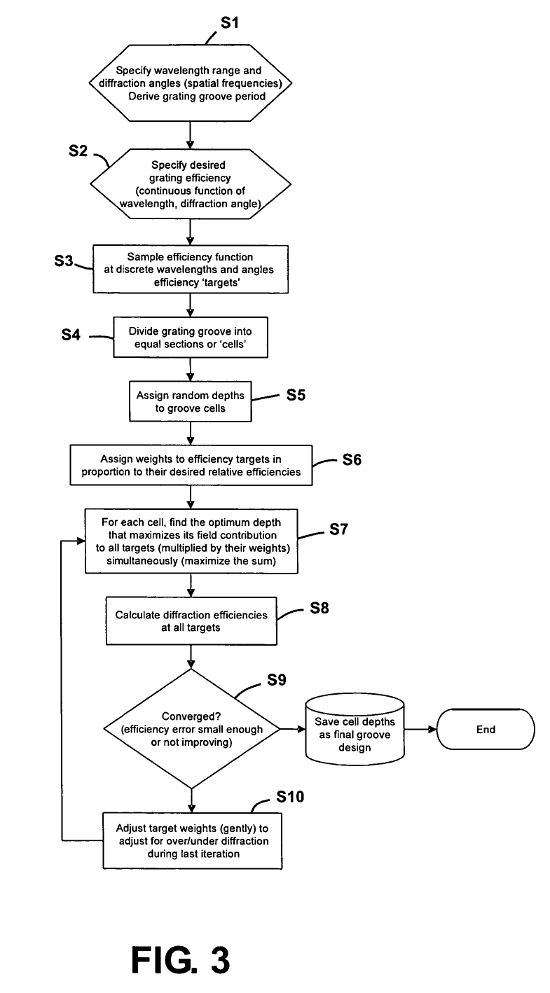

FIG. 2 shows an example of a structured grating profile.

The present disclosure allows a structured-groove grating profile to be designed in order to optimize the performance and fit the efficiency to a predetermined desired spectral response. To accomplish this, a design algorithm is provided that is carried out completely within the spatial frequency domain.

The spatial frequency spectrum from a grating is described by the diffraction order linewidth function multiplied by the efficiency function from a single grating groove. Reference can be made to Equation (1.1) of the section ‘Diffracted Field Calculation’ of Annex A.

The above expression is a separable one, so that only the response from one single grating groove has to be considered to determine the response for the entire grating. In particular, the use of such expression provides a major efficiency and accuracy advantage since it reduces the calculation domain to only one period of the grating, as opposed to the whole grating area. Use of an algorithm with high efficiency and accuracy is important for extensions into 2D designs and polarization aspects.

In a first step of the method according to the disclosure, targets are defined for the spectral range under interest. These targets are relative efficiency measures that represent the desired spectral response of the grating in certain spatial frequencies calculated from the diffraction order and wavelength.

In particular, the following steps are performed:

In a first step, a desired grating efficiency vs. wavelength function is provided;

In a second step, the function is sampled at target wavelength to allow the function to be represented.

In a third step the grating groove is divided into a number of cells, typically 100.

In a fourth step, the phase contribution is determined from each cell by the incident wave and the local height of the grating profile in that particular location, as shown by Equations (1.6) and (1.7) of Annex A.

In a fifth step, the total contribution from all cells is calculated to each target by integrating the contribution from all cells, as shown by Equation (1.8) of Annex A. The method described here and in Annex A is a scalar approximation of the solution of Maxwell's equations for the case of electromagnetic scattering (diffraction) from a periodic structure. An exact vector solution of Maxwell's equations could also be used to find the contribution from all cells to the targets. Such a solution would include the polarization state of the light, and hence targets could be independently defined for orthogonal polarizations. The targets for orthogonal polarizations could be set to behave the same or different, such that different efficiency functions could be realized for each polarization.

In a sixth step, the optimum rotation angle (ORA) method is used in the spatial frequency domain to adjust the individual heights of each cell so that the total response from all cells is optimized, as shown in section C of Annex A. The optimization may be carried out by finding the cell depths that maximize the target-weighted contributions to all targets simultaneously (definition of ORA method), or alternatively, by finding the cell depths that minimize the errors in the target efficiencies simultaneously. A wide variety of such optimization ‘merit functions’ may be devised to achieve desired grating performance to suit a particular application.

The above sixth step is iterative and continues until the design specifications are met.

It should be noted that if an unphysical desired response is defined, the design algorithm of the present disclosure anyway tries to generate a grating groove profile that, as closely as possible, fulfills the design specification.

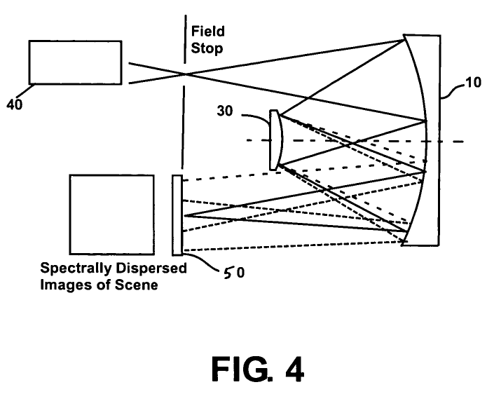

FIG. 3 shows a flowchart of an algorithm used in accordance with the method of the present disclosure.

In a step S1, the wavelength range and the diffraction angles (spatial frequencies) are specified and the grating groove period is derived. The diffraction angle is determined by the wavelength, for a given groove period (width). The optical spatial frequency is determined by the diffraction angle and the wavelength.

In a step S2, the desired grating efficiency is specified as a continuous function of the wavelength and the diffraction angle.

In a step S3, the efficiency function is sampled at discrete wavelengths and angles to establish the efficiency targets.

In a step S4, the grating groove is divided into equal sections or cells.

In a step S5, random depths are assigned to the groove cells.

In a step S6, weights are assigned to the efficiency targets in proportion to their desired relative efficiencies.

After step S6, a loop comprised of steps S7-S10 begins. In step S7, for each cell, the optimum depth is determined that maximizes its weighted contribution to all targets simultaneously (ORA method). As described above, alternative definitions of the optimum cell depth may be employed.

In step S8, the diffraction efficiencies are calculated at all targets.

In decision step S9, the algorithm converges if the efficiency error is small enough or is not converging. Otherwise, the algorithm goes to step S10 where the target weights are adjusted and the loop is repeated starting at S7.

Annex A shows three examples in accordance with the present disclosure. Reference is made to the ‘Experiments’ section of Annex A.

The structured gratings in accordance with the present disclosure can be fabricated with techniques such as electron beam (E-beam) lithography. The applicants have successfully developed design algorithms and E-beam fabrication techniques for structured groove gratings that realize desired efficiency vs. wavelength curves.

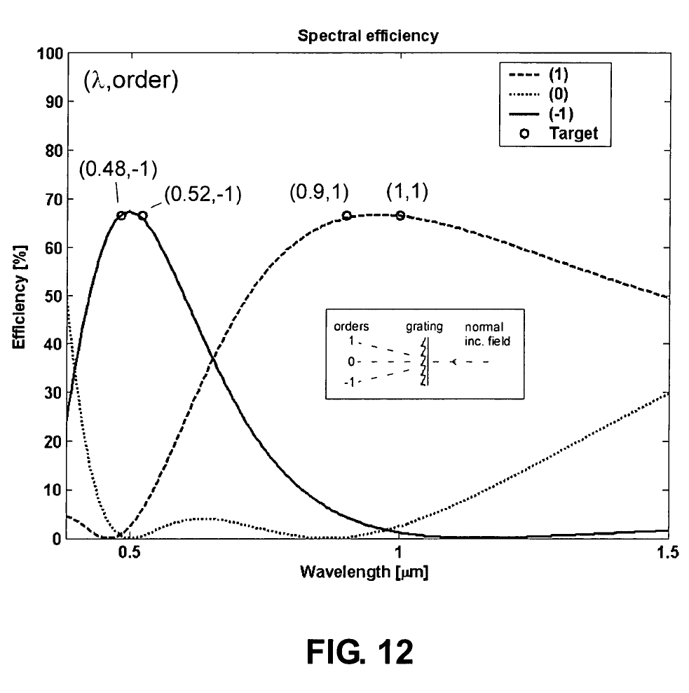

For example, the grating structures designed in the examples of Annex A were E-beam fabricated along with a standard sawtooth grating and their efficiencies measured, as shown in FIG. 11.

An important application of the concepts of the present disclosure is that the grating can be designed to match a given spectrometer's source illumination and detector responsivity curve that optimizes the signal-to-noise and imaging performance of an instrument, with clear gains over current grating technology.

Specifically, in the visible-near-infrared (VNIR) wavelength band (0.4-1.0 microns), it would be desirable for the grating efficiency to be flat, or even inverse of the silicon detector responsivity curve. On the other hand, in the short-wave infrared (SWIR) band (1-2.5 microns), the grating efficiency should balance the falling solar blackbody curve. If a vector electromagnetic field solver is used in the grating design algorithm, then the grating efficiency for orthogonal field polarizations can specified to minimize or maximize a grating's sensitivity to polarized scenes.

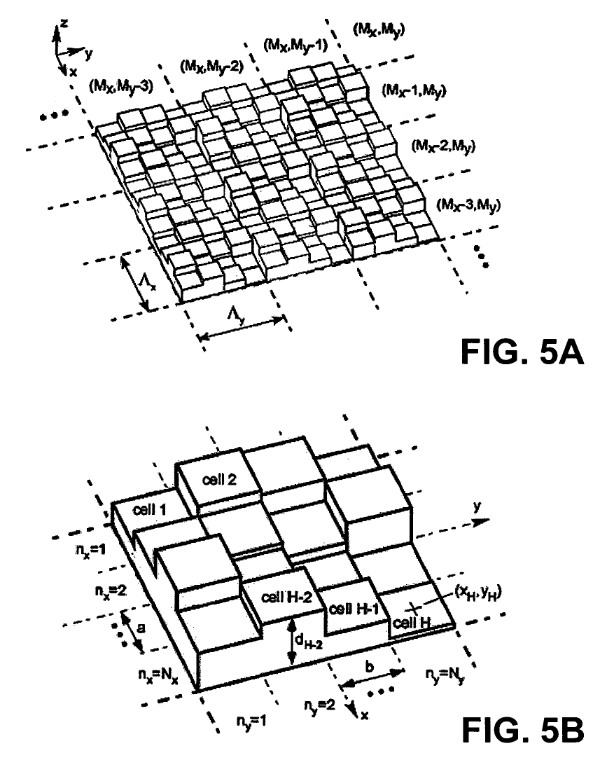

A further application of the teachings of the present disclosure is to optimize the performance of two-dimensional (2D) gratings for computed-tomography imaging spectrometers (CTISs), as shown in FIG. 4.

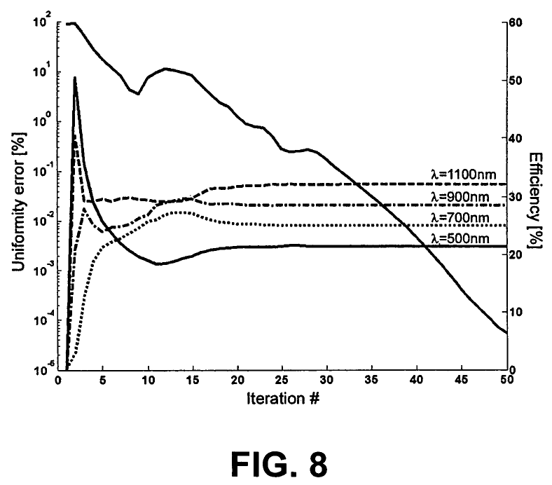

FIG. 4 shows a schematic view of a reflective CTIS optical system comprising a concave mirror 10, a focal plane array 20 and a convex 2D grating 30 manufactured in accordance with the present disclosure. The optical signal coming from a primary telescope 40 is reflected by the mirror 10, diffracted by grating 30 and focalized by array 50 to show spectrally dispersed images of the optical signal. In particular, the CTIS of FIG. 7 uses the 2D grating 30 to generate multiple spectrally-dispersed images of a 2D scene without scanning or moving parts. A tomographic reconstruction algorithm is then used to determine the spectrum of every pixel in the scene.

CTISs are described, for example, in U.S. Pat. No. 6,522,403, incorporated herein by reference in its entirety, and in the following three publications, all of which are also incorporated herein by reference in their entirety:
1. W. R. Johnson, D. W. Wilson, and G. H. Bearman, “All-Reflective Snapshot Hyperspectral Imager for UV and IR Applications,” Opt. Lett., vol. 30, pp. 1464-1466, Jun. 15, 2005.
2. W. R. Johnson, D. W. Wilson, and G. H. Bearman, “An all-reflective computed-tomography imaging spectrometer,” in Instruments, Science, and Methods for Geospace and Planetary Remote Sensing, Carl A. Nardell, Paul G. Lucey, Jeng-Hwa Yee, and James B. Garvin eds., Proc. SPIE 5660, pp. 88-97 (2004).
3. M. R. Descour, C. E. Volin, E. L. Dereniak, T. M. Gleeson, M. F. Hopkins, D. W. Wilson, and P. D. Maker, “Demonstration of a computed-tomography imaging spectrometer using a computer-generated hologram disperser,” Appl. Optics., vol. 36 (16), pp. 3694-3698, Jun. 1, 1997.

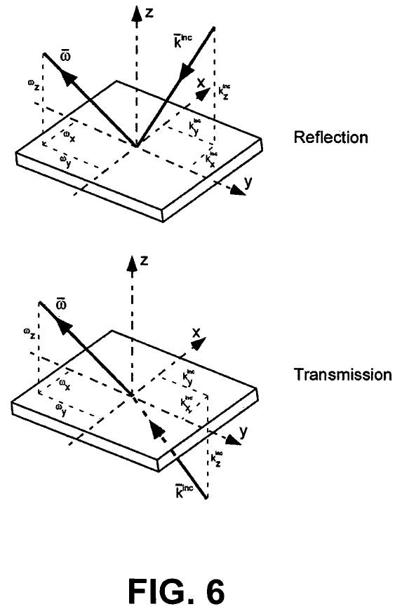

FIGS. 5-16 will be discussed in detail in the enclosed Annex A.

While several illustrative embodiments of the invention have been shown and described in the above description and in the enclosed Annex A, numerous variations and alternative embodiments will occur to those skilled in the art. Such variations and alternative embodiments are contemplated, and can be made without departing from the scope of the invention as defined in the appended claims.

### ANNEX A

### Design of one- and Two-dimensional Structured-groove Diffraction Gratings for Control of Spectral Efficiency

Abstract

A grating design algorithm that enables optimization of the spectral response of phase gratings by introducing structure into the grating groove profile is presented. The aim is to optimize the grating response for a specific task, e.g., to extend the spectral range compared to conventional blazed gratings, or to design the efficiency to compensate for a detector response curve as a function of wavelength. The algorithm is not limited to controlling only one diffraction order—several orders can be simultaneously optimized over a wide wavelength range. In addition, the algorithm is general and can be used for one- and two-dimensional gratings, for large diffraction angles, and for both reflection and transmission mode. Three examples are presented. Each one was designed, fabricated, and experimentally evaluated. The experimental results are compared with both scalar and vectorial simulations. The measured performance closely resembles the design prediction for all three gratings experimentally evaluated.

Introduction

Today, diffraction gratings are used for a wide range of applications in diverse fields such as remote sensing, biomedicine, defense, and telecommunications. Traditionally, the method used to accomplish high diffraction efficiency over a limited wavelength range has been to fabricate blazed gratings with an accurately controlled blaze angle. In recent years however, the rapid development of compact optics and wide spectral range detectors has enabled more advanced and compact spectroscopic systems. Diffraction gratings with conventional profiles (blazed, sinusoidal, etc.) have shown limited flexibility and spectral range in some cases to fully optimize the spectral and imaging properties of instruments. Imaging spectrometers, for example, operating in the solar reflected spectrum (400-2500 nm) require broadband response if the entire range is to be covered with a single grating [1]. Also, the ability to tailor the response permits optimization of the overall system signal-to-noise ratio. For example, the quantum efficiency of silicon detectors typically shows a strong peak towards the middle of the useful wavelength range. If the grating response emphasizes the edges of the spectrum while suppressing the middle, a more balanced overall system response can be obtained. An even more challenging example is the design of broadband two-dimensional gratings for computed-tomography imaging spectrometers.[2] These gratings must produce a two-dimensional array of controlled-efficiency orders to avoid focal plane array saturation and to optimize the tomographic reconstruction of spectral images.

The work presented here is aimed to fully realize the potential of diffraction gratings that have optimized efficiency and tailored spectral response. To design such gratings, the Applicants have developed a flexible grating design algorithm that takes advantage of the ability to fabricate precisely structured groove shapes with modern electron beam lithography systems. Such systems enable arbitrary grating profile structures to be fabricated on flat or curved substrates with high accuracy [3,4].

The design algorithm presented in this Annex originates from an existing algorithm, the optimum-rotation angle method (ORA), used to design focused spot patterns at multiple focal planes in the real space domain. It has been used to design both free space [5,6] and waveguide [7] diffractive optical elements (DOEs) with simultaneous focusing of several wavelengths. The ORA-design is known for its flexibility and accuracy for large diffraction angles as long as the fully scalar theory is applicable. The Applicants have adopted the ORA technique to optimize diffraction orders within the spatial frequency domain (or Fourier domain) as a function of wavelength. In the spatial frequency domain the diffracted field from a particular grating profile is analytically calculated from the sampling of the grating profile into an array of cells. The ORA technique is then used to optimize each grating cell such that the grating profile as a whole diffract light in the desired directions as a function of wavelength. The procedure is iterative and continues until the desired performance has been reached.

Other grating design algorithms exist such as Fresnel integral and Fast Fourier Transform (FFT) based methods that are useful for controlling the diffraction order efficiency for several orders but at one single design wavelength [8,9]. There is, however, a multi-spectral grating design method in the literature that has been developed to design two-dimensional computer-generated hologram gratings [10,11]. This method is FFT-based and assumes small diffraction angles and a single reference wavelength must be chosen. The same applies to other related spectral algorithms including the design of synthetic spectrums for correlation spectroscopy [12] and wavelength demultiplexing functions [13].

Another method for designing the spectral efficiency is to divide the grating area into two or more grating zones, where for example, one zone is efficient at shorter wavelengths and another zone at longer wavelengths. The disadvantage with this configuration can be the aperture apodization as a result of the different efficiencies; one zone is basically active at a time. With the design presented here only one zone contributes to the whole spectrum without the apodization effect.

The design method presented in this paper allows one single grating profile to be efficiency-optimized at many wavelengths and diffraction orders simultaneously. The algorithm is general and the total spectral response can be tailored even if the diffraction angles are fairly large. One single diffraction order can be tailored over a large desired spectral band or many diffraction orders can be simultaneously tailored depending on the type of application. Another advantage is its independence of a uniform fixed sampling of the grating period. Instead, the sampling cells can be of any shape and size depending on the specific grating design. Thus, it is not restricted to the discrete set of spatial frequencies, as for transfer or transforms matrix-based methods. Furthermore, the maximum grating depth can be chosen arbitrarily depending on the design. Conventional methods are restricted to the depth that generates 2π phase shift at the design wavelength or at a reference wavelength. Here, any depth can be specified arbitrarily and the design algorithm will find the optimized solution for the current value. Some gratings benefit from having deeper grooves while others are restricted to shallower groves due to fabrication difficulties. Also, the slope of the spectral response as a function of wavelength for individual orders can be controlled by adjustment of the grating depth.

An important issue to consider when introducing structure into the grating groove profile is the polarization dependence. If the minimum feature within one grating period is larger than the longest wavelength it is designed for, the grating structure should not be significantly polarizing. This is the situation for many real cases. However, when the minimum feature size of the structure is close to or less than the wavelength it can cause undesired polarization behavior. It will be shown how large this effect is for different grating periods and structures in the last section when comparing experiments with simulations.

The outline of the Annex is a follows. In Sec. 1, a description of the algorithm is presented for the most general case: a two-dimensional grating profile that can easily be simplified to the one-dimensional grating case. The derivation is divided into two parts. The first part describes how the diffracted field is calculated in any arbitrary diffraction order as a function of wavelength and furthermore, how this is used to calculate the total grating efficiency. The second part describes how the ORA technique is applied to find the optimized grating profile. Then, three different grating examples that were designed, fabricated, and experimentally evaluated, are shown. The first example is a one-dimensional grating that provides useful efficiency over a large wavelength range. The second example is a short period grating that demonstrates the accuracy of the algorithm when the grating structure feature size is on the order of the wavelength. The final example is a two-dimensional grating with four separate diffraction orders simultaneously optimized where the orders are efficient over different spectral regions. The experimental results are compared with simulations for all three cases.

Grating Design Algorithm

A. Diffracted Field Calculation

The spatial frequency distribution generated when collimated incident light impinges on a general periodic structure or grating can be described as,

$$\tilde{E} ( {ω}_{x} , {ω}_{y} ) = \frac{1}{{M}_{x} \cdot {M}_{y}} ( {\sum }_{{m}_{x} = 1}^{{M}_{x}} {\sum }_{{m}_{y} = 1}^{{M}_{y}} exp ( - ⅈ ( {ω}_{x} {x}_{n} + {ω}_{y} {y}_{m} ) ) ) \cdot \tilde{{E}^{s}} ( {ω}_{x} , {ω}_{y} ) \qquad ( 1.1 )$$

This expression is a normalized summation of the field contribution over all grating periods, (Mₓ,M_{y}). The field, \tilde{E}^{s}(ωₓ, ω_{y}), represents the normalized spatial frequency distribution from one single grating period centered at (x=0, y=0), and has been taken out of the summation in Eq.1.1 since it is identical for all grating periods. Furthermore, Eq.1.1 has been normalized to represent the diffraction efficiency rather than the intensity then taking the modulus of, \tilde{E}(ωₓ, ω_{y}). A schematic of a sampled grating is shown in FIG. 5A where it has been drawn like a chessboard to distinguish the periods from each other.

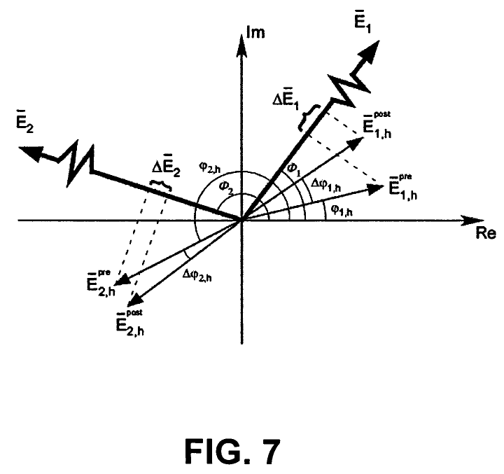

Now, when designing a grating profile only the diffraction order efficiencies are of concern that are characterized by a discrete set of spatial frequencies at a given wavelength. These discrete components are determined by the grating equation,

$$\begin{matrix}{ω}_{x} ( λ , n ) = \frac{2 π n}{{Λ}_{x}} + {k}_{x}^{inc} \\ {ω}_{y} ( λ , m ) = \frac{2 π m}{{Λ}_{y}} + {k}_{y}^{inc}\end{matrix} \qquad ( 1.2 )$$

where, (Λₓ, Λ_{y}), is the grating period, (kₓ^{inc}, k_{y}^{inc}) is the k-vector components in x and y for the incident field, and (n,m) is the order number in x and y, respectively. The coordinate system definition of the incident k-vector and the diffracted ω-vector is shown in FIG. 6, for both reflection and transmission gratings. The incident k-vector for the transmission grating case is defined inside the grating material and the transmitted light is dependent on the refractive index of that material, n, (λ), (taking the dispersion of the grating material into consideration if required). For convenience, any combination of spatial frequencies that fulfill the grating equation, Eq.1.2, will be denoted as {ωₓ(λ,n), ω_{y}(λ,m)}, where n=±1, 2, 3, . . . and m=±1, 2, 3, . . . represent the diffraction order index in x and y, respectively. The sign convention for the diffracted orders is shown in FIG. 6. It can be shown that by inserting the grating equation, Eq.1.2, into Eq.1.1 it reduces to,
\tilde{E}(ωₓ(λ,n), ω_{y}(λ,m))=\tilde{E}^{s}(ωₓ(λ,n), ω_{y}(λ,m)) (1.3)
Thus, only one grating period centered at, (x=0, y=0), needs to be accounted for when determining the grating efficiency in an arbitrary order and wavelength independent on how many grating periods that constitutes the grating.
B. Efficiency Calculation for an Arbitrary Diffraction Order

In the previous section it was concluded that only the spatial frequency spectrum from one single grating period is required to determine the diffraction efficiency from a grating for any arbitrary diffraction order, wavelength, and incident angle. This section describes how the spatial frequency spectrum for an arbitrary grating profile is calculated for the general 2D grating.

To represent an arbitrary grating profile, the grating period area determined by (Λₓ,Λ_{y}) is sampled uniformly into (Nₓ, N_{y}) cells. The shape of the cell can be of any kind but for convenience we chose a rectangular shape, (a,b), as shown in FIG. 5B. The grating cells are numbered from h=1, 2, . . . , H. The spatial frequency spectrum is calculated for each single cell individually assuming that each cell acts as a small aperture in the diffraction plane. The amplitude emitted from a cell is the same for all cells but the phase is different determined by the location of the cell within the period, the incident phase at the cell center, and the profile height, dₕ. The incident field is assumed to be a plane wave described by, (kₓ^{inc}, k_{y}^{inc}, k_{z}^{inc}), as depicted in FIG. 2. By Fourier transforming analytically the field from one single cell in the diffraction plane, in the spatial frequency domain the field becomes,

$$\begin{matrix}{\tilde{E}}_{h} ( {ω}_{x} , {ω}_{y} ) = A ( {ω}_{x} , {ω}_{y} ) exp ( - ⅈ ( {ω}_{x} {x}_{h} + {ω}_{y} {y}_{h} ) ) exp ( ⅈ ( {k}_{x}^{inc} {x}_{h} + {k}_{y}^{inc} {y}_{h} ) ) exp ( {ⅈφ}_{h} ) \\ \text{where} & ( 1.4 ) \\ A ( {ω}_{x} , {ω}_{y} ) = ab sin c ( \frac{a}{2} ( {ω}_{x} - {k}_{x}^{inc} ) ) sin c ( \frac{b}{2} ( {ω}_{y} - {k}_{y}^{inc} ) ) & ( 1.5 )\end{matrix}$$

Above, (xₕ, yₕ), is the cell center coordinate within the grating period with respect to a local coordinate system with its origin at the grating period center and dₕ is the profile height of that cell, as illustrated in FIG. 5B. The first term in Eq.1.4 is a point spread function that determines the field amplitude strength as a function of spatial frequency component. It has been shifted due to an angled incident field. The second term describes the phase change for a non-centered cell, (xₕ, yₕ), with respect to the local coordinate system, as illustrated in FIG. 5B. The third term describes the phase of the incident field at, (xₕ, yₕ) and the last term determines the phase contribution due to the grating profile height, dₕ.

The relationship between the cell height, dₕ, and the corresponding phase contribution to the field, φₕ=k_{z}^{T}dₕ, is different for reflection and transmission gratings,

$$\begin{matrix}{k}_{z}^{T} = 2 {k}_{z}^{inc} ( reflection ) \\ {k}_{z}^{T} = {k}_{z}^{inc} - {k}_{z}^{refr} ( transmission ) where , & ( 1.6 ) \\ {k}_{z}^{refr} = \sqrt{{( \frac{2 π}{λ} )}^{2} - {( {n}_{r} {k}_{x}^{inc} )}^{2} - {( {n}_{r} {k}_{y}^{inc} )}^{2}} . & ( 1.7 )\end{matrix}$$

Equation 1.7 is the z-component of the wave vector after refraction through the grating cell surface into air. Further, k_{z}^{inc} is the z-component of the incident wave vector in air or in the grating material depending on if it is a reflection or transmission grating, respectively. Observe that the coordinate system in FIG. 6 was used in the derivation of Eq. 1.6 and thus, k_{z}^{inc}, is negative for reflection gratings and positive for transmission gratings. Note that Eq.1.6 is accurate even then the incident angle is large. Furthermore, the last term of Eq.1.4 is the only term that dependents on the grating profile height, dₕ, which is a required property for the application of the ORA-technique. Note also that, k_{z}^{refr}, the dispersion of the grating material, can be accounted for by including a wavelength dependent refractive index, nᵣ(λ).

Finally, the total normalized spatial frequency field coming from one grating period as a function of wavelength and order is calculated by summing the contributions from the grating cells,

$$\tilde{E} ( {ω}_{x} ( λ , n ) , {ω}_{y} ( λ , m ) ) = \frac{1}{{Λ}_{x} {Λ}_{y}} {\sum }_{h = 1}^{H} {\tilde{E}}_{h} ( {ω}_{x} ( λ , n ) , {ω}_{y} ( λ , m ) ) \qquad ( 1.8 )$$

C. ORA in the Spatial Frequency Domain

In the previous section the normalized spatial frequency field, \tilde{E}(ωₓ,ω_{y}), was calculated for an arbitrary diffraction order and wavelength. This section describes how the optimized grating profile cell height, dₕ, is determined by applying the ORA-technique and using the calculated fields from the previous section.

The design input parameters to the algorithm are the period, the sampling of the grating period, the maximum grating depth, and the incident field direction. The desired spectral response of the grating is specified to the algorithm by choosing a number of design specific spatial frequency targets. Each target is identified by a unique set of frequencies each with a relative efficiency; (ωₓ(λ,n), ω_{y}(λ,m), W_{d}(λ,n,m)). The targets are placed along the spectrum with the proper relative efficiency and spectral separation such that they sample a desired spectral response curve. The spectral separation between targets is determined for each grating design individually. Targets too close require unnecessary computation time but too sparse a separation may generate uncontrolled and undesired spectral response. The spectral response between the target positions tends to be fairly smooth if they are properly separated. The details on how the targets are chosen will be described in the next section.

To illustrate how the optimum choice of the cell height, dₕ, is calculated two arbitrary targets are considered. The efficiency and phase of the field in the target spatial frequencies, \tilde{E}₁ and \tilde{E}₂, is best depicted through a complex plane representation, as shown in FIG. 7. The shorter vectors denoted, \tilde{E}_{1,2}^{pre,post}, represent the field and phase contribution from one single cell h to the two spatial frequency targets before and after a change in grating profile height, Δdₕ. This profile height change, Δdₕ, is transferred into a phase change, Δφₕ, by using Eq.1.6 above,
Δφₕ=Δdₕk_{z}^{T} (1.9)
Now, by looking at the field vectors in FIG. 7 the total field change for the targets due to the cell change of one cell h is given by,
Δ\tilde{E}(ωₓ(λ,n), ω_{y}(λ,m), Δφₕ)=cos (Φ−φₕ−Δφₕ)−cos (Φ−φₕ) (1.10)
Important to notice in FIG. 7 is that a change in the profile height, Δdₕ, increases the field in one target but for another target the field is decreased. Therefore, the optimum choice of the profile height change, Δdₕ, is based on the total field change for the two target positions together. Thus, for an arbitrary number of targets the total field-change is a summation over all targets,

$$Δ \tilde{E} ( Δ {φ}_{h} ) = {\sum }_{( λ , n , m )} Δ \tilde{E} ( {ω}_{x} ( λ , n ) , {ω}_{y} ( λ , m ) , Δ {φ}_{h} ) \qquad ( 1.11 )$$

The best choice of, Δdₕ, is obtained when Eq.1.11 is maximized. Since the expression above contains an arbitrary number of trigonometric functions that depends on the target parameters a general analytical solution does not exist and a numerical technique must be used. The search range for the optimum depth change, Δdₕ, depends on the previous value of, dₕ, and the maximum allowed grating depth, dₘₐₓ Thus, the depth change range for a cell h is, (Δdₕ∈−dₕ:(dₘₐₓ−dₕ)).

Furthermore, to adjust the efficiency relation between the targets, weights are introduced into Eq.1.10,
Δ\tilde{E}(ωₓ(λ,n), ω_{y}(λ,m), Δφₕ)=W(λ,n,m)[cos (Φ−φₕ−Δφₕ)−cos (Φ−φₕ)] (1.12)
These weights adjust the relative efficiency contribution to the targets. If there is less light than specified for a target the weights makes it more rewarding to direct light into this order compared to a target with too much light. Thus, the design algorithm tries to distribute the diffracted light into the targets as specified in the design. From here Eq.1.12 is used in Eq.1.11 for the total field change calculation. By maximizing Eq.1.11, the design algorithm tries to direct as much light as possible into the targets with the desired relative efficiency. If the choice of targets is unphysical, the algorithm will anyway try to find a best case with the smallest deviation from design specification.
D. Optimization Algorithm

In the previous section it was shown how the optimum grating height change was calculated for a set of targets. This section describes how the final optimized grating profile is obtained. This procedure is identical to the original ORA and can be studied in more detail in [5-7].

The ORA technique is iterative and starts by generating a random cell height map. The total field in all target spatial frequencies is then calculated based on these random cell heights by using Eq.8. The algorithm then optimizes the first grating cell by maximizing Eq.1.11 assuming that the total fields calculated for all target spatial frequencies are kept constant throughout the iteration. After the first cell has been optimized the algorithm continues to the next cell and so on until all cells have been optimized. Then, the total field in the target spatial frequencies is recalculated based on these new grating heights. The weights are adjusted based on the calculated field values in the targets and the desired design target relative efficiency, W_{d},

$$W = {{W}^{old} ( \frac{{W}_{d}}{{\vert \tilde{E} \vert}^{2}} )}^{q} \qquad ( 1.13 )$$

where, |\tilde{E}|², is the modulus of the calculated target spatial frequency field and, W^{old}, is the previous iteration weight value. In Eq.1.13 the factor, q, controls the convergence and stability of the algorithm. The value of q is typically between 0.01 and 0.5 depending on the complexity of the design.

A new iteration then starts by optimizing the first cell based on these new target field values and weights. The quantity that determines the performance and quality of the latest iteration is the uniformity error given by,

$$UE = \frac{max ( \frac{{\vert \tilde{E} ( λ , n ) \vert}^{2 }}{{W}_{d} ( λ , n )} ) - min ( \frac{{\vert \tilde{E} ( λ , n ) \vert}^{2 }}{{W}_{d} ( λ , n )} )}{max ( \frac{{\vert \tilde{E} ( λ , n ) \vert}^{2 }}{{W}_{d} ( λ , n )} ) + min ( \frac{{\vert \tilde{E} ( λ , n ) \vert}^{2 }}{{W}_{d} ( λ , n )} )} \qquad ( 1.14 )$$

which is calculated for each target.

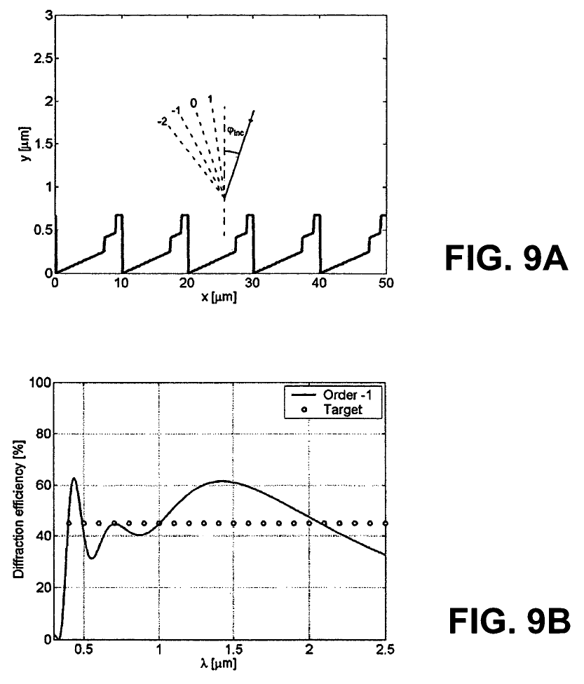

The iterative procedure continues until the desired uniformity error has been attained or if the desired performance is within acceptable limits over the whole spectral range even if there is a discrepancy for a few targets. FIG. 8 is an example of the design performance. For demonstration, a two-dimensional grating was designed with only four targets, each with a different relative efficiency, wavelength, and diffraction order. The number of grating cells was (40×40) and each iteration took about 5s on a 1.7 Ghz computer. The figure shows how the algorithm adjusts the relative efficiency (right scale) to the targets design specification through the uniformity error decrease (left scale). It should be mentioned that more targets will require increased computation time which is usually the case for more advanced designs.

E. Stability of the Algorithm

Since the optimization is carried out over a wavelength range and not at one single wavelength the stability of the algorithm becomes an issue. The algorithm starts with a random generation of grating cell heights. The design algorithm then tries to find an optimum. For complicated tasks a number of local optimums may exist. However, by executing the algorithm a number of times these local optimums are revealed since the initial condition is never the same. Usually, the local optimums differ both in performance and grating profile shape. Depending on the optical performance and fabrication complexity of the grating profile it is up to the designer to decide which solution represents a best choice. The spectral range and complexity of the design task determines the stability of the algorithm that can be partially controlled by an appropriate choice of the convergence factor, q. The maximum allowed grating depth, dₘₐₓ, is also important for the stability.

Experiments

In this section, three different examples are presented that where designed, fabricated and experimentally evaluated. The experimental result was compared with theory in each example.

### EXAMPLE 1

### 1D Reflection Grating

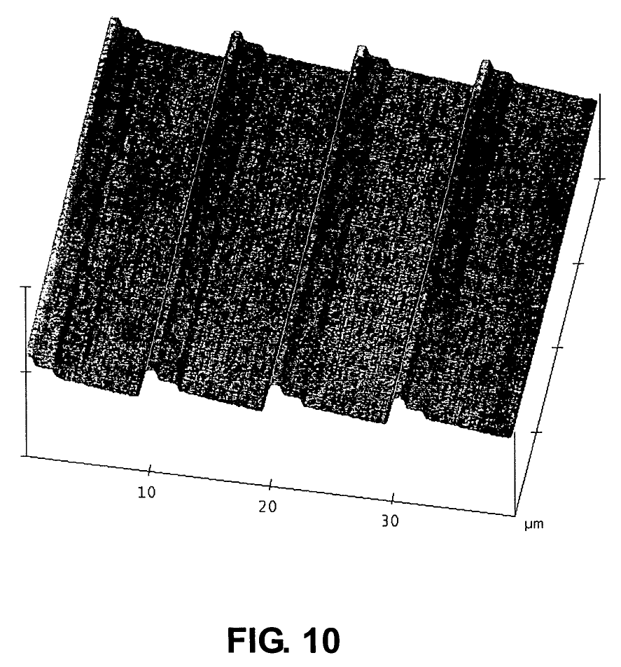

The first example is a one-dimensional reflection grating aimed to provide continuous and high efficiency over the whole solar black body radiation spectrum (400-2500 nm) through one single diffraction order, n=−1. The grating period was Λ=10 μm uniformly divided into Nₓ=100 cells where each cell was a=0.1 μm and the incident angle was φ^{inc}=10°, as depicted in FIG. 9A. The maximum grating depth was dₘₐₓ=1 μm. The targets were specified along the spectrum with constant spacing to ensure continuous and flat efficiency response along the entire spectral range. The targets are identified by (λ,−1) and placed at λ=0.4, 0.5, . . . , 2.4, 2.5 μm. Each target is shown as a circle in FIG. 9B.

The design algorithm was executed several times and with slightly different maximum grating depth values to ensure that all possible local extremes were found. The best grating profile structure and spectral characteristic is shown in FIGS. 9A and 9B, respectively. It should be noted that two other solutions also resulted with the same uniformity error but with more complicated structures and approximately the same performance. The simulated performance is not perfectly uniform over the entire spectral range. However, if the solution is compared to the efficiency of a pure blazed grating, shown as the dotted curve in FIG. 11, the integrated efficiency over the whole wavelength range is about the same for both gratings. The solution thus represents an efficient solution with a minimum uniformity error without loosing total efficiency. The spectral response has variations along the spectrum, but trying to make the curve more uniform will result in reduced total efficiency and more complex profiles.

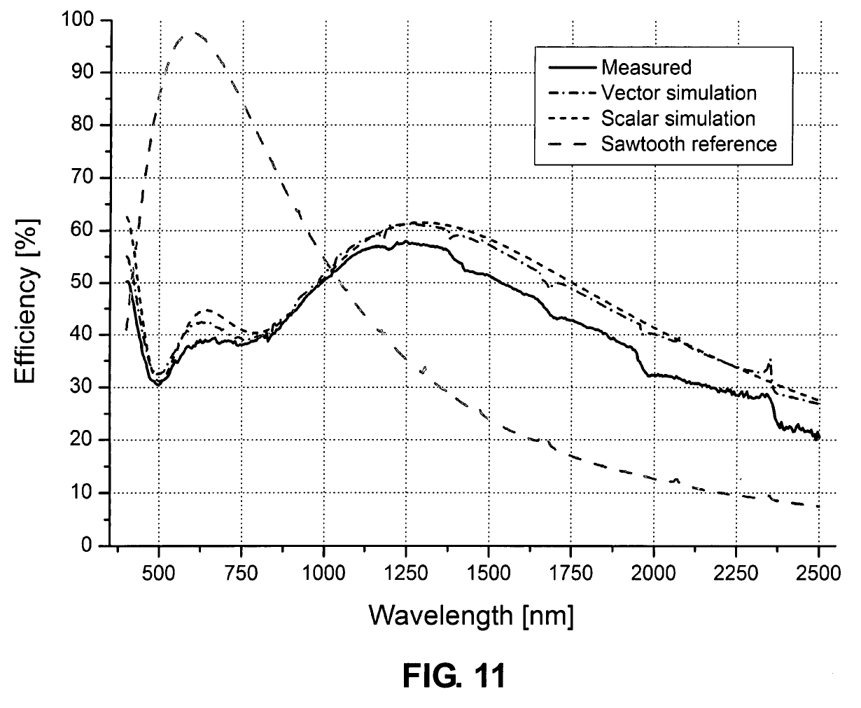

The grating was fabricated on a one-inch diameter quartz substrate spin-coated with PMMA (950 K) 5% to a thickness of 1.8 mm and then baked at 170 C for 20 minutes. A 10 nm aluminum discharge layer was thermally evaporated onto the surface to avoid charging of the resist during the electron beam exposure. The grating was written with a JEOL JBX-9300FS electron beam lithography machine at 100 kV acceleration voltage and 20 nA beam current. After exposure, the A1-discharge layer was removed and the grating was developed in a time-controlled flow of acetone, using multiple steps to achieve the proper depth. Finally, a reflective coating of 50 nm aluminum was thermally evaporated on the grating. An atomic force microscope (AFM) profile of the fabricated grating is shown in FIG. 10. More details regarding fabrication can be found in Ref. 12.

The grating was evaluated experimentally using a monochrometer system capable of measuring over the reflected solar black body radiation spectrum, 0.38-2.5 mm. The setup is computerized with order sorting filters and gratings that are switched in automatically as the wavelength is scanned. The measured spectral efficiency is presented in FIG. 11 (black). The grating profile was also simulated with commercial software (PCGrate 2000 MLT by IIG Inc.) based on vectorial electro-magnetic theory. The input grating profile to the simulation was the same profile as shown in FIG. 9A but recessed to 91% of its designed value. The recess was because of insufficient development time during fabrication that resulted in a small grating depth error and consequently a blue-shift of the spectral response; in this case with about 40 nm. The gray curve in FIG. 11 shows the simulated result with the vectorial method. For comparison the light gray curve is included to shows the result simulated with a scalar method. The kinks along the measured curve are predicted by the vectorial simulation and are due to the “Wood's anomalies” that result from transverse-magnetic polarized light coupling to the grating surface at wavelengths where diffraction orders are transitioning from propagating to evanescent.[14] Because these order cut-off wavelengths are determined by the grating period, they do not shift with grating depth. Finally, the scalar simulation shows that the scalar based design closely resembles the result form the vectorial simulation and experiments. Thus, the scalar ORA design algorithm is accurate for this design task.

### EXAMPLE 2

### 1D Transmission Grating with Small Features

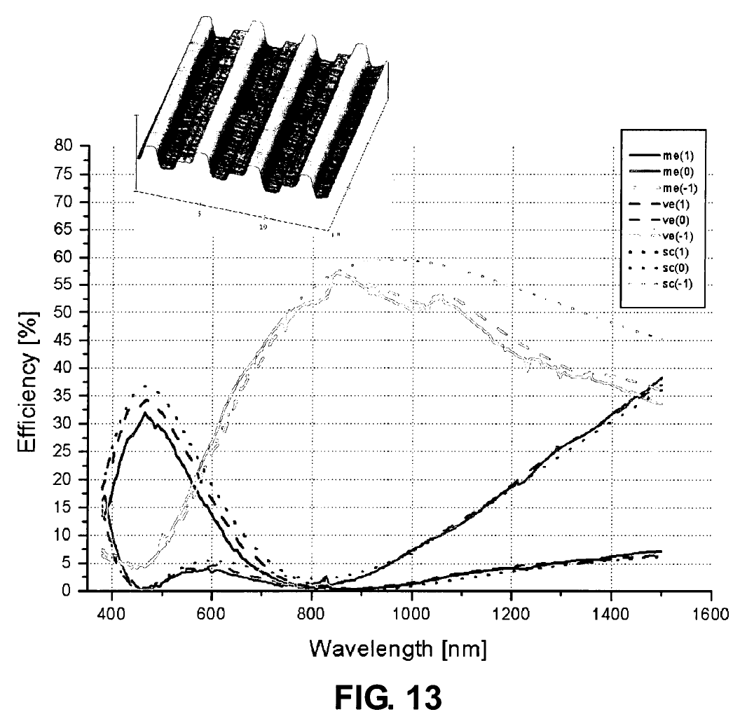

This example optimizes two diffraction orders simultaneously, (1) and (−1), in transmission mode where each order is desired to be efficient over separate spectral bands. A schematic is shown as an inset in FIG. 12. The grating period was only Λ=4 μm divided into Nₓ=40 cells and the maximum grating depth was dₘₐₓ=1.3 μm. The incident field direction was (φ^{inc}=0° and the dispersion of the resist was assumed to be negligible over the spectral range, nᵣ=1.5 (PMMA). The choice of design targets is depicted in FIG. 12 where each target is identified with its wavelength and order within parenthesis. Thus, two targets where chosen for order (−1) to center an efficiency peak at 500 nm and, two targets for order (1) to center its efficiency peak at 950 nm. The simulated efficiency response for the designed grating profile is shown in FIG. 12.

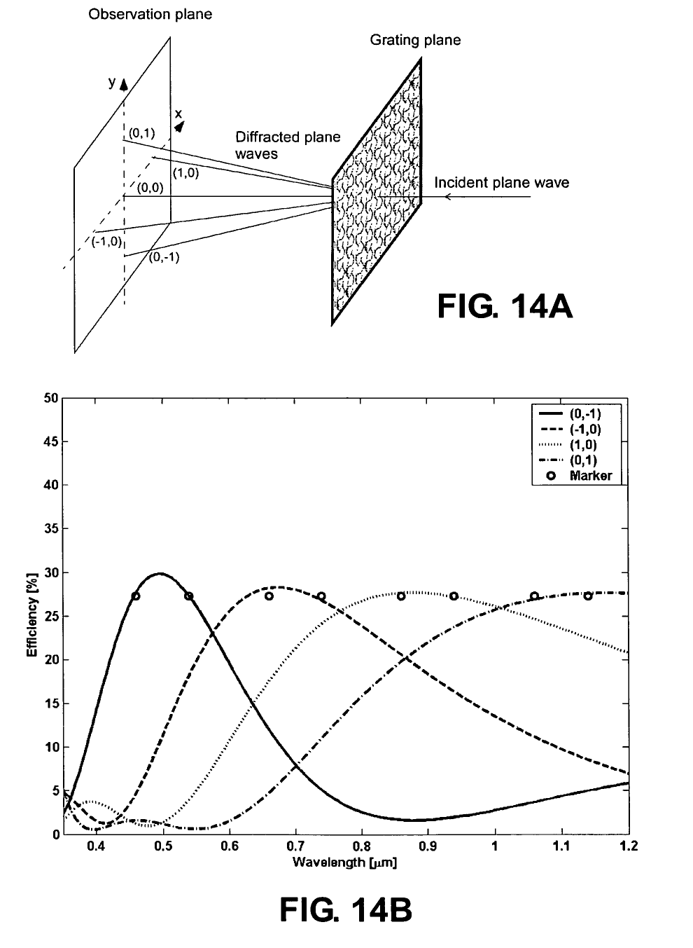

The grating was fabricated in the same way as the first example but without the reflective A1-layer. The measurements were carried out in an identical manner as for the first example except that two orders had to be measured in transmission mode instead of one in reflective mode. The small period made the measurement more challenging due to the larger shift in diffraction angle as a function of wavelength. The measured result of the fabricated grating is shown in FIG. 13 along with an inset showing an AFM picture of the fabricated grating profile. When comparing the simulated response of the design in FIG. 12 with the measured response in FIG. 13 that they do not match well for the short wavelength peak for order (−1).

To ensure that the grating profile was fabricated as designed, the Applicants measured the fabricated grating profile with the AFM and used that profile as the input to both the vectorial and scalar simulation tools. The result is shown in FIG. 13 as the dashed and dotted curves, respectively. It is obvious that the lower efficiency for order (−1) is not only an optical effect because of the small features of the grating but rather a fabrication effect. The fabricated grating profile did not perfectly resemble that of the design (the developer did not dissolve the resist material as effective for narrow and small features opposed to larger features). However, the resemblance between the measured and the vectorial simulation is very good over the entire wavelength span if the measured profile is used. The scalar counterpart gives a good representation also but deviates somewhat for order (1) for λ>900 nm. The deviation is not significant but indicates that the feature size for this grating is small and as the wavelength increases polarization effects becomes more pronounced.

### EXAMPLE 3

### 2D Transmission Grating

This example is a two-dimensional transmission grating aimed to demonstrate the utility of the algorithm for designing gratings for computed-tomography imaging spectrometers.[2] However, in order to demonstrate the principle and the spectral characteristics of the grating we have restricted the design to only accommodate for four diffraction orders instead of a large array. It should be emphasized that an arbitrary number of orders can be included in the design if required as for most CTIS-designs.

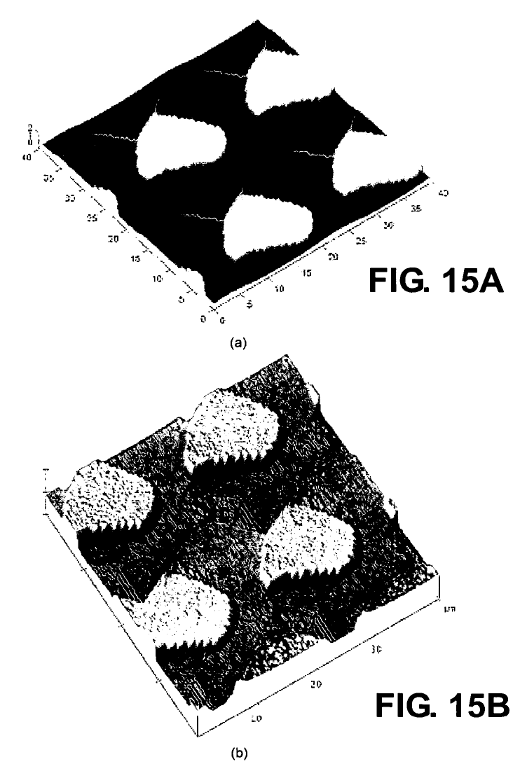

The diffraction orders (0,−1),(−1,0),(1,0), and (0,1), were optimized simultaneously with efficiency peaks at 0.5, 0.7, 0.9, and 1.1 mm, respectively. The grating period was Λₓ, Λ_{y}=10 μm and divided into Nₓ, N_{y}=40 cells. The maximum allowed grating depths was, dₘₐₓ=1.5 μm, and the incident angle was φ^{inc}=0°. As for the previous example, the dispersion of the resist was assumed to be negligible over the spectral range, nᵣ=1.5 (PMMA). Again, dispersion can be included in the design if necessary by including a wavelength dependent refractive index of the grating material, nᵣ(λ). A schematic picture of the setup is shown in FIG. 14A .

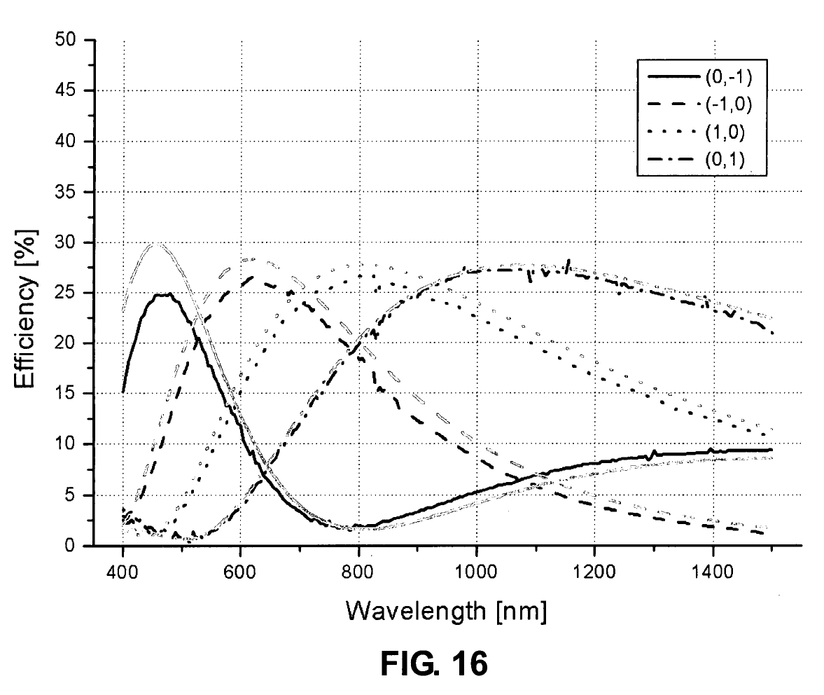

As can be seen in FIG. 14B, the targets (shown as circles), were chosen in pairs, each pair representing one diffraction order separated by 80 nm to fix the spectral position of the efficiency peak. The separation between each efficiency peak was aimed to be 200 nm. The simulated spectral response from the designed grating, using a scalar method, is shown in FIG. 14B. Unfortunately, no vectorial simulation tool could be used for comparison for this two-dimensional design due to the magnitude of the calculation for such a case. However, since the period was large for this design one can expect that the polarization effect is fairly small. The designed grating profile is shown in FIG. 15A. The profile has no rapid oscillations and should not show significant polarization behavior.

The fabrication was carried out in the same manner as for the previous examples. An atomic force microscopic picture of the fabricated grating is presented in FIG. 15B. The grating was evaluated with the same setup as for the other examples. The measured efficiency curves for all four diffraction orders are shown in FIG. 16. The simulated performance (light gray curves) has been included for comparison. The grating depth was recessed to 92% of the designed grating depth due to insufficient development time. It can be seen that the efficiency is lower for shorter wavelengths compared to the simulation than for longer wavelengths. The Applicants believe that this is related to surface roughness that scatters more light at shorter wavelengths compared to longer wavelengths. Furthermore, the simulated result shows close resemblance with the scalar simulation indicating negligible polarization behavior.

### CONCLUSION AND SUMMARY

Presented in this Annex is a design algorithm capable of designing precisely controlled structured grating profiles that control and optimize the spectral efficiency of the gratings in any arbitrary diffraction order as a function of wavelength. The algorithm can be used for both 1D and 2D-gratings in either reflection or transmission mode. The advantage using this method compared to earlier algorithms is its ability to optimize the performance at many wavelengths simultaneously and its accuracy, especially important for gratings where the diffraction angles can be quite large.

The algorithm is essentially not limited to only grating design. With minor modifications it could likewise be used to spectrally design diffractive optical elements (DOEs) in fixed spatial frequencies. This is useful when designing spectral filters and particularly interesting in correlation spectroscopy where the generation of a synthetic spectrum is required [12].

Three different examples were presented, all fabricated and experimentally tested. All three examples show good experimental resemblance with the design specification even if the grating period was fairly small compared to the wavelength. As expected, polarization effects are inevitable for gratings that have periods and groove-features that are close to the wavelength.

### REFERENCES

1. P. Z. Mouroulis, D. W. Wilson, P. D. Maker, and R. E. Muller “Convex grating types for concentric imaging spectrometers”, Appl. Opt. 37, 7200-7208 (1998).

2. M. R. Descour, C. E. Volin, E. L. Dereniak, T. M. Gleeson, M. F. Hopkins, D. W. Wilson, and P. D. Maker, “Demonstration of a computer-tomography imaging spectrometer using a computer-generated hologram disperser”, Appl. Opt. 36, 3694-3698 (1997).

3. D. W. Wilson, P. D. Maker, R. E. Muller, P. Mouroulis, and J. Backlund, “Recent advances in blazed grating fabrication by electron-beam lithography”, in Current Developments in Lens Design and Optical Engineering IV, P. Mouroulis, W. J. Smith, and R. B. Johnson Eds., Proceedings of SPIE Vol. 5173 (SPIE, Bellingham, Wash., 2003), pp. 115-126.

4. D. W. Wilson, R. E. Muller, P. M. Echternach, and J. P. Backlund, “Electron-beam lithography for micro- and nano-optical applications,” in Micromachining Technology for Micro-Optics and Nano-Optics III, edited by Eric G. Johnson, Gregory P. Nordin, Thomas J. Suleski, Proceedings of SPIE Vol. 5720 (SPIE, Bellingham, Wash., 2005), pp. 68-77.

5. J. Bengtsson, “Design of fan-out kinoforms in the entire scalar diffraction regime with an optimal-rotation-angle method”, Appl. Opt. 36, 8453-8444 (1997).

6. J. Bengtsson, “Kinoforms designed to produce different fan-out patterns for two wavelengths”, Appl. Opt. 37, 2011-2020 (1998).

7. J. Backlund, J. Bengtsson, C -F Carlstrom, and A. G. Larsson, “Input waveguide grating couplers designed for a desired wavelength and polarization response”, Appl. Opt. 41, 2818-2825 (2002).

8. R. W. Gerchberg and W. O. Saxton, “A practical algorithm for the determination of phase from image and diffraction plane pictures”, Optik 35, 237-246 (1972).

9. J. W. Goodman, Introduction to Fourier Optics, 2^{nd} ed. (McGraw-Hill, New York, 1996).

10. C. E. Volin, M. R. Descour, and E. L. Dereniak, “Design of broadband-optimized computer generated hologram dispersers for the computation-tomography imaging spectrometer”, in Imaging Spectroscopy VII, Proceedings of SPIE Vol. 4480 (SPIE, Bellingham, Wash., 2002), 377-387.

11. J. F. Scholl, E. L. Dereniak, M. R. Descour, C. P. Tebow, and C. E. Volin, “Phase grating design for a dual-band snapshot imaging spectrometer”, Appl. Opt. 42, 18-29 (2003).

12. M. B. Sinclair, M. A. Butler, A. J. Ricco, and S. D. Senturia, “Synthetic spectra: a tool for correlation spectroscopy”, Appl. Opt. 36, 3342-3348 (1997).

13. B. -Z. Dong, G. -Q. Zhang, G. -Z. Yang, B. -Y. Yuan, S. -H. Zheng, D. -H. Li, Y. -S. Chen, X. -M. Cui, M. -L. Chen, and H. -D. Liu, “Design and fabrication of a diffractive phase element for wavelength demultiplexing and spatial focusing simultaneously”, Appl. Opt. 35, 6859-6864 (1996).

14. A. Hessel and A. A. Oliner, “A New Theory Of Woods Anomalies On Optical Gratings”, Appl. Opt. 4, 1275-1297. (1965).

What is claimed is:

1. A method for designing a groove profile of a grating comprising:
defining one or more targets as spatial frequency components within a predetermined spectral range, said targets being based on wavelength and diffraction order;
dividing the grating groove into a number of sections;
defining a relation between a grating profile comprised of said sections and a diffraction efficiency in said spatial frequency components; and
adjusting individual heights of each section.

2. The method of claim 1 wherein adjusting individual heights of each cell is obtained by means of an optimum rotation angle method, to obtain efficiencies in the spatial frequency components as described by the targets.

3. A method for fabricating a periodic diffractive optical element, comprising:
specifying a wavelength range and diffraction angles of the diffractive optical element;
specifying a desired efficiency of the diffractive optical element;
sampling an efficiency function for the diffractive optical element at discrete wavelengths and diffraction orders, thus defining efficiency targets;
dividing a grating area of the diffractive optical element into depth cells; and
finding a desired value for each depth cell.

4. The method of claim 3, wherein finding a desired value for the depth section comprises:
for each depth section, finding an optimum depth that maximizes a field contribution of said depth section to the efficiency targets;
calculating diffraction efficiencies at the targets; and
adjusting target weights if said desired value is not obtained.

5. The method of claim 4 further comprising, if said desired value is not obtained, repeating the steps of claim 4.

6. A diffraction grating comprising:
a structured groove profile,
wherein said structured groove profile is optimized to achieve a desired efficiency vs. wavelength function.

7. The diffraction grating of claim 6, wherein said structured groove profile is optimized by way of an optimal rotation angle algorithm applied to a spatial frequency domain.

8. The grating of claim 6, wherein said grating is a one-dimensional diffraction grating.

9. The grating of claim 6, wherein said grating is a two-dimensional diffraction grating.

10. The diffraction grating of claim 6, wherein said diffraction grating is a reflective diffraction grating.

11. The diffraction grating of claim 6, wherein said diffraction grating is a transmissive diffraction grating.

12. A computed-tomography imaging spectrometer (CTIS) comprising the diffraction grating of claim 8.

13. The CTIS of claim 12, further comprising a concave mirror and a focal plane array associated with the reflective diffraction grating.

14. A spectral domain method to obtain a desired efficiency of a plurality of grooves in a diffraction element, comprising:
specifying relative efficiency targets at specific wavelengths and diffraction orders;
defining grooves as comprising pixel depths;
for each pixel, finding a pixel depth that optimizes a field contribution of said pixel to all targets simultaneously;
calculating diffraction efficiencies for all targets;
adjusting target weights; and
repeating said adjusting until said desired efficiency is obtained or stagnation occurs.

15. The method of claim 14, where the diffraction efficiencies are calculated using a scalar electromagnetic analysis.

16. The method of claim 14, where the diffraction efficiencies are calculated using a vector electromagnetic analysis.

17. The method of claim 14, wherein the pixel depth to be found maximizes a field contribution of said pixel to all targets simultaneously.

18. The method of claim 14, wherein the pixel depth to be found minimizes an error in target diffraction efficiencies simultaneously.

19. The method of claim 14 where said targets are chosen for orthogonal polarizations at discrete wavelengths and diffraction orders.
